(19) United States
(12) Patent Application Publication
(10) Pub. No.: US 2026/0254522 A1
(43) Pub. Date: Aug. 27, 2026

(54) METHOD AND APPARATUS OF INDICATION OF RX BEAM ASSUMPTION

(71) Applicant: MEDIATEK INC., Hsinchu City (TW)

(72) Inventors: Yu-Jen KU, San Jose, CA (US); Gyu Bum KYUNG, San Jose, CA (US)

(73) Assignee: MEDIATEK INC., Hsinchu City (TW)

(21) Appl. No.: 19/472,803

(22) PCT Filed: Jul. 26, 2024
(86) PCT No.: PCT/CN2024/107722

§ 371 Date: Oct. 6, 2025

Related U.S. Application Data
(60) Provisional application No. 63/516,176, filed on Jul. 28, 2023.

(51) Int. Cl. H04B 7/06

(52) U.S. Cl. CPC H04B 7/0696

(57) ABSTRACT

In an aspect of the disclosure, a method, a computer-readable medium, and an apparatus are provided. The apparatus may be a UE. The UE determines an indication indicative of a receive (RX) beam assumption from a base station. The UE determines, based on the indication, a measurement method of a beam measurement set. The UE determines, based on the determined measurement method, a measurement result of the beam measurement set.

### CROSS-REFERENCE TO RELATED APPLICATION(S)

This application claims the benefits of U.S. Provisional Application Ser. No. 63/516,176, entitled “METHOD AND APPARATUS OF INDICATION OF RX ASSUMPTION FOR MODEL INPUT FOR AL/ML-BASED BEAM MANAGEMENT” and filed on Jul. 28, 2023, which is expressly incorporated by reference herein in its entirety.

### TECHNICAL FIELD

The present disclosure relates generally to wireless communications, and more particularly, to techniques of beam reporting for artificial intelligence/machine learning (AI/ML) based beam management in wireless communication systems.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE determines an indication indicative of a receive (RX) beam assumption from a base station. The UE determines, based on the indication, a measurement method of a beam measurement set. The UE determines, based on the determined measurement method, a measurement result of the beam measurement set.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7(A) is a diagram illustrating an AI/ML (artificial intelligence/machine learning) model for spatial and temporal domain beam prediction.

FIG. 7(B) is a diagram illustrating the temporal aspects of beam measurement and prediction in AI/ML-based beam management.

FIG. 8 illustrates a flow chart 800 of a process for beam reporting in an AI/ML-based beam management system.

FIG. 9(A) illustrates a diagram 910 depicting a first type of RX beam assumption and a corresponding measurement method of the UE.

FIG. 9(B) illustrates a diagram 930 depicting a second type of RX beam assumption and a corresponding measurement method of the UE.

FIG. 9(C) illustrates a diagram 950 depicting a third type of RX beam assumption and a corresponding measurement method of the UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

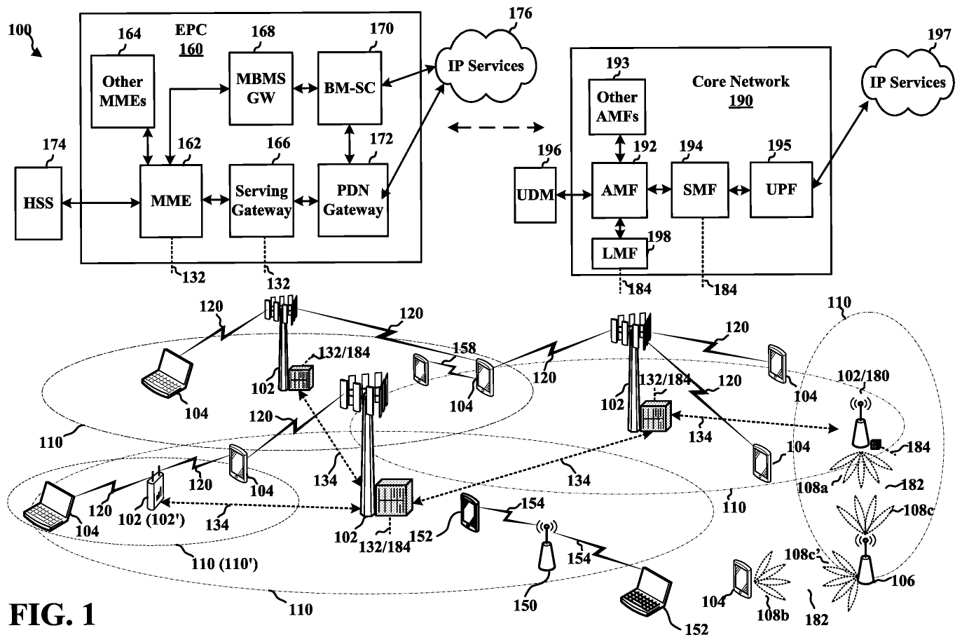

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHZ unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

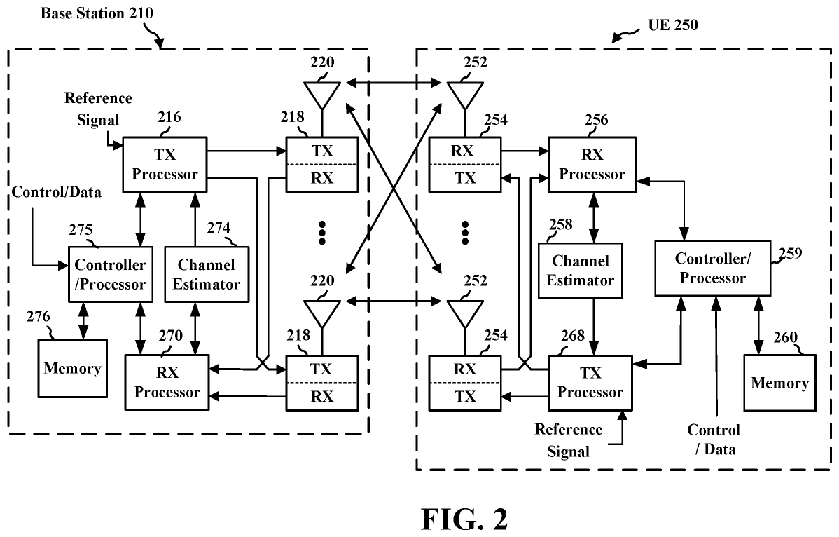

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

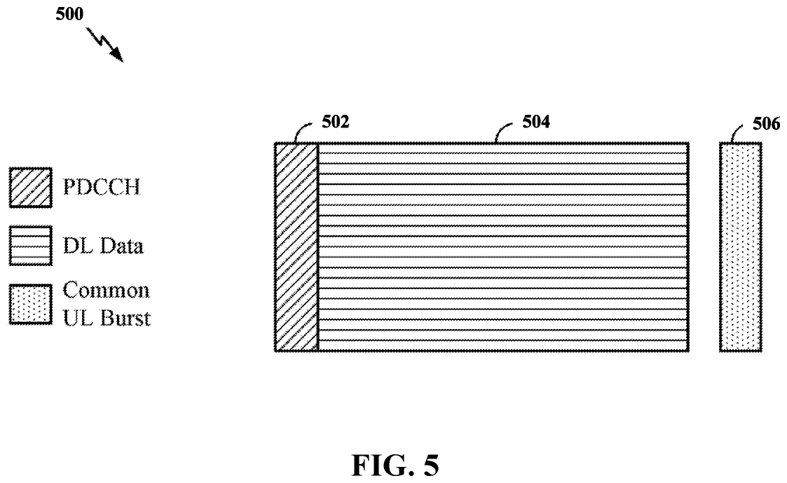

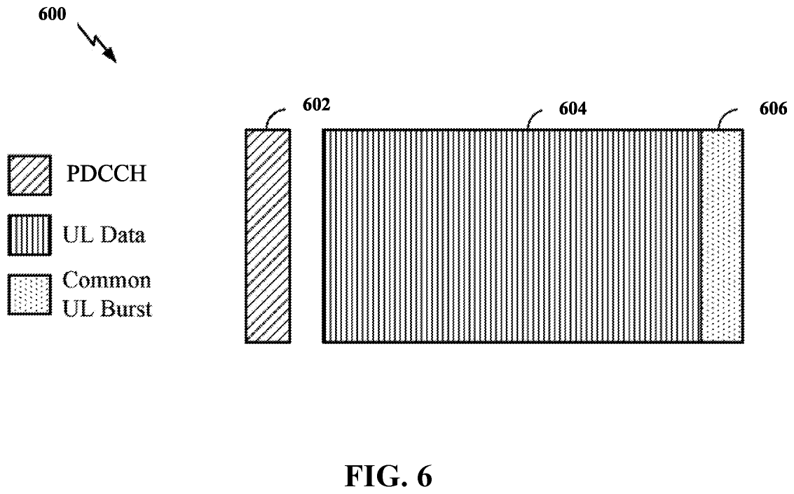

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

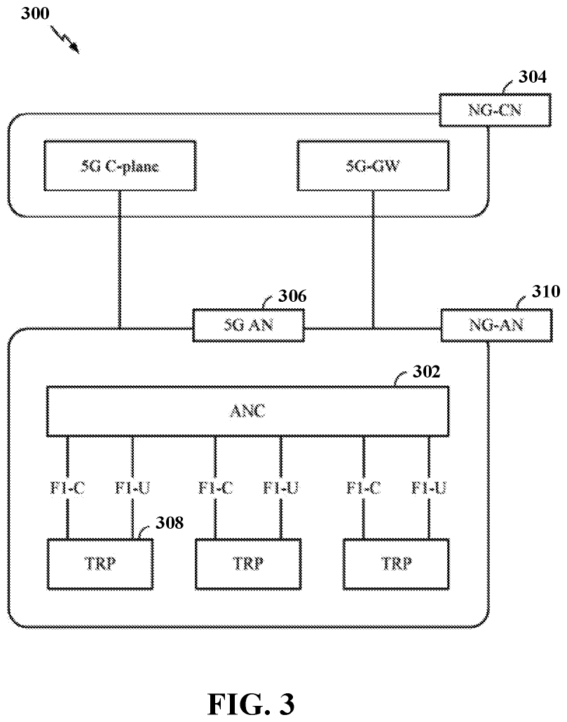

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

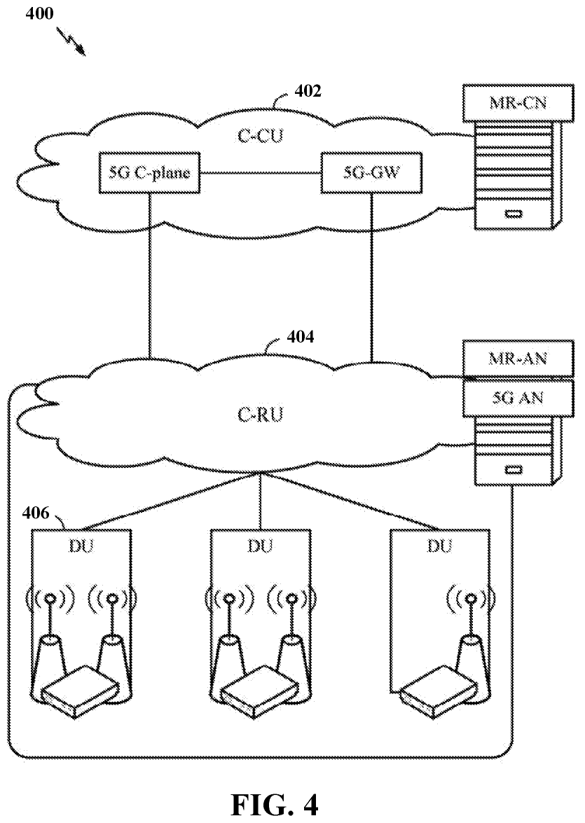

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

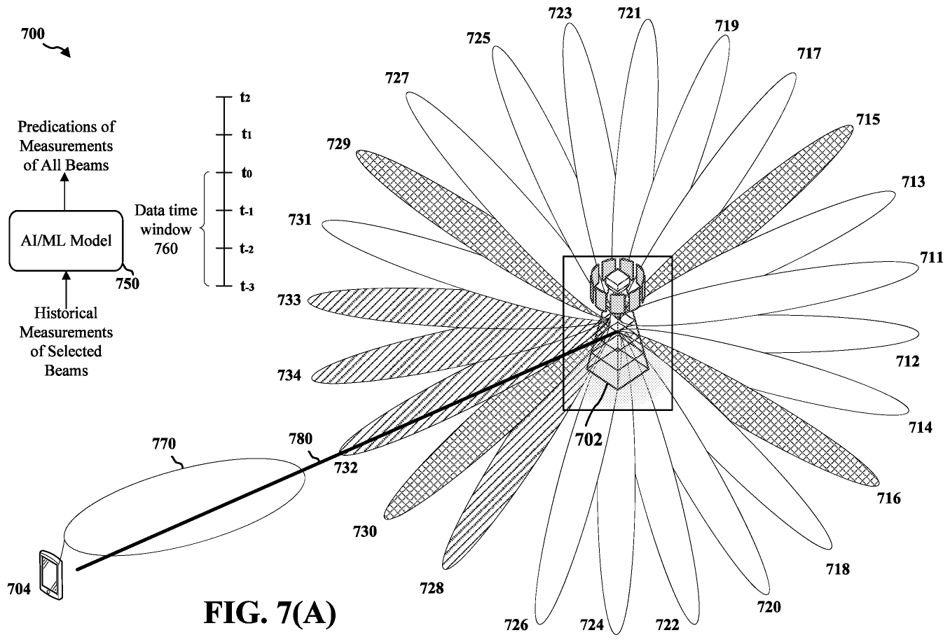

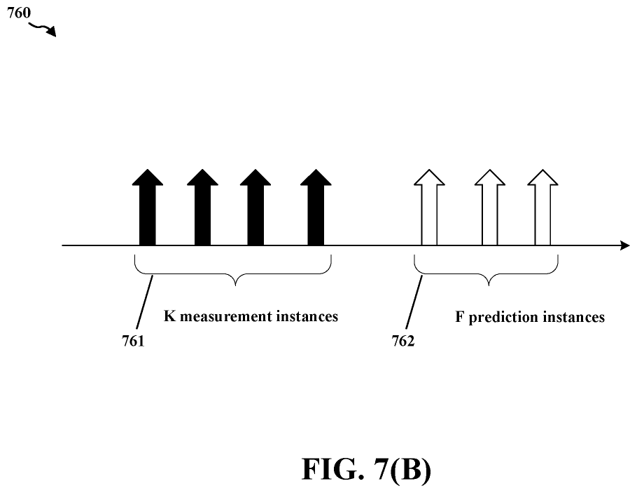

FIG. 7(A) is a diagram 700 illustrating an AI/ML (artificial intelligence/machine learning) model for spatial and temporal domain beam prediction. In this example, the base station 702 simultaneously transmits beams 711-734 in various directions via channel 780. After identifying incoming beams, the UE 704 can compute Layer 1 Reference Signal Received Power (L1-RSRP) for each beam. L1-RSRP is the average received power of the resource elements that carry the secondary synchronization signals or channel state information reference signals (CSI-RS).

Machine learning algorithms are used to analyze the history of signal strengths from a subset of beams and attempt to find patterns or trends in the data. This helps predict the signal strengths of the remaining unmeasured beams. By identifying patterns in historical data from the subset of beams, the algorithm can predict signal strengths of the other beams even as the UE is moving.

In this example, the base station 702 is equipped with multiple antennas and is capable of simultaneously radiating 24 different beams 711-734 in various directions. The UE 704, which moves from time to time, may be equipped with its own antenna and periodically measures channel indicators such as RSRP from 4 beams (e.g. beams 715, 716, 729, and 730) selected from the 24 beams radiated by the base station 702. The set of beams (e.g. beams 715, 716, 729, and 730) measured as AI/ML input (sensing beams) is referred to as beam Set B. The set of beams (e.g. the 24 beams) that is being predicted as AI/ML output (usually communication beams) is referred to as beam Set A.

The measurements collected from these 4 beams are saved over time as historical data. The historical data captures how the channel indicators for the subset of beams change over time, capturing how the UE 704 interacts with those beams. The UE 704 may be configured with a historical data time window 760 during which measurements are stored in the UE 704. In this example, the current time is t₀. The historical data time window 760 spans from time t₋₃ to t₀. Measurement data for the subset of beams 715, 716, 729, and 730 obtained during the historical data time window 760 are stored in the UE 704 and used as input to the AI/ML model 750 to predict measurements of unmeasured beams at the current time t₀ as well as measurements of all the beams at future times t₁, t₂.

The historical data serves as input to a machine learning algorithm to predict channel indicators for unmeasured beams, guiding the UE 704 on which beams to focus when it needs to communicate with the base station 702. The algorithm can thus predict channel indicators for all beams based on analyzing patterns and trends in the historical data from the subset of beams.

Another set of beams (e.g. beams 711, 721, 724, and 734) that are not normally measured under regular circumstances can be sampled periodically and their channel indicators recorded. This can be used to validate if the algorithm's predictions match actual performance while also updating the AI/ML model. Periodic measurements help improve the algorithm by updating its weights and parameters. As the machine learning algorithm matures, its predictions of the best beams will become increasingly accurate. When the UE 704 initiates communication, it can select the UE transmit or receive beam 770 that is likely to yield superior signal quality (e.g. the best beam) based on the prediction.

Rather than identifying a single best beam, the method predicts the top-k beams that are likely to have the highest channel indicators. In many cases, focusing on the top-k beams can provide excellent accuracy. The top-k beam prediction is achieved by estimating them based on the top-k channel indicator values. This aligns very well with real-world communication needs, improving system performance.

The main output of a classification-based AI/ML model includes identifiers (IDs) of the predicted top-k best beams for communication, along with corresponding predicted confidence scores or predicted RSRP for each beam. These beams are determined to be most suitable for communication based on expected signal strength and reliability. For example, if k is set to 5, the model might predict that the five best communication beams in the entire beam set are the beams numbered 732, 730, 734, 728, and 733. This prediction enables the UE 704 to make an informed decision on which beams the base station 702 and UE 704 should use to communicate at any given time, optimizing performance based on signal strength and likelihood of successfully transmitting data.

Furthermore, the output of a regression-based AI/ML model includes predicted RSRP values for each communication beam in beam Set A. This predicted output directly estimates the expected signal strength of each individual beam in the communication set, allowing the UE 704 to select beams more granularly based on the predicted RSRP values.

Beamforming, a technique for enhancing data rates and reliability in 5G and beyond wireless communication, especially in millimeter wave (mmWave) frequencies, enables a base station, such as the base station 702, to focus its signal transmission and reception toward a specific user equipment (UE), such as the UE 704. This targeted approach improves signal quality and reduces interference. To establish an optimal beam connection, the base station 702 and the UE 704 need to identify the best beams to transmit and receive data, a process known as beam management. Traditional beam management often involves exhaustive beam sweeping, where the base station 702 and the UE 704 systematically scan through all available beam directions to find the best one. However, this method becomes inefficient and resource-intensive as the number of antennas and beams increases, leading to significant overhead.

AI/ML-based beam management, in contrast, offers a more agile and efficient alternative to exhaustive beam sweeping. By using the power of machine learning, this approach predicts the optimal beams for communication based on analyzing patterns in historical data obtained from a subset of beams.

As illustrated in FIG. 7(A), rather than measuring all 24 beams, the UE 704 selectively measures the L1-RSRP from a smaller subset of beams, denoted as beam Set B, which serves as input to an AI/ML model 750. By analyzing patterns and trends in the historical data from this subset of beams, the AI/ML model 750 predicts the L1-RSRP values for the remaining unmeasured beams in beam Set A.

The AI/ML model 750 may take various forms, such as classification-based or regression-based models. A classification model predicts the top-k best beams for communication and provides associated confidence scores. A regression model directly estimates the RSRP values for each communication beam in beam Set A. Regardless of the chosen model, this predictive capability significantly reduces the need for exhaustive measurements, minimizing overhead and enhancing efficiency.

Temporal beam prediction, a key aspect of AI/ML-based beam management, predicts future optimal beam indices based on historical beam measurements. The UE 704 uses measurements taken over a historical data time window 760, allowing the model 750 to learn temporal patterns and anticipate future beam conditions.

In essence, AI/ML-based beam management provides a faster and more efficient way to obtain the best beam information, optimizing beam selection for communication between a base station and a UE, especially in dynamic environments where beam conditions may change rapidly.

FIG. 7(B) is a diagram 760 illustrating the temporal aspects of beam measurement and prediction in AI/ML-based beam management. The figure shows two sequences: a measurement sequence 761 and a prediction sequence 762.

The measurement sequence 761 represents K measurement instances, where the UE 704 conducts beam measurements. These measurements are typically performed on a subset of beams (e.g., beam Set B), which serves as input to the AI/ML model. These measurements provide the power measurements of the sensing beams, which are used to infer the optimal communication beams.

The prediction sequence 762 represents F prediction instances, where the AI/ML model predicts the future optimal beam indices. These predictions are based on the beam measurements from the previous time steps, specifically the measurements taken during the K measurement instances.

This temporal structure aligns with the concept of temporal beam prediction, where the goal is to predict future optimal beam indices using the beam measurements on the sensing beams from previous time steps. The RSRP of one or more beams can be predicted with an input of historical RSRPs.

That is, the measurement sequence 761 corresponds to the time instances for which the UE 704 reports actual measurements. The prediction sequence 762 represents the future time instances for which the AI/ML model (either at the UE 704 or the base station 702) predicts beam conditions.

In advanced wireless communication systems, such as 5G and beyond, beamforming may enhance data rates and reliability, particularly in millimeter wave (mmWave) frequencies. The base station 702 and the UE 704 need to identify the optimal beams for communication, a process known as beam management. Traditional beam management often involves exhaustive beam sweeping, which becomes inefficient as the number of available beams increases. To address this challenge, AI/ML-based beam management has been proposed as a more efficient alternative.

If an AI/ML model is at the UE side, it processes the measurements from Set B to predict the best beams in Set A. If the model is at the network side, the UE 704 reports the measurements of Set B, allowing the network to perform the prediction.

The disclosed techniques address the challenge of aligning the Rx beam assumption between the network (NW) and the User Equipment (UE) 704 in AI/ML-based beam management systems. This alignment is useful for the NW to construct an effective AI/ML model and for the UE 704 to provide accurate model input measurements.

Based on the disclosed techniques, the NW may implicitly indicate the desired Rx beam assumption to the UE 704 without additional signaling overhead. This may be achieved by using the inherent differences in the configuration patterns of Reference Signal (RS) resources and report configurations for different Rx beam assumptions.

The disclosed techniques are directed to three types of Rx beam assumptions:
1. Best Rx beam assumption (Type 1): In this type, the NW configures Periodic (P) or Semi-Persistent (SP) CSI-RS for beams in Set B. The UE 704 sweeps all its Rx beams for each Tx beam in Set B and reports the best measurement. The NW configuration includes:
   A CSI-ReportConfig with associated RS resources set to Periodic or Semi-Persistent resource Type
   The periodicityAndOffset of the associated resources
   The reportSlotConfig in CSI-ReportConfig
   These configurations allow the UE 704 to sweep multiple Rx beams.
2. Specific Rx beam assumption (Type 2): The NW configures two sets of Aperiodic (AP) CSI-RS resources:
   The first set has repetition configured to “on” for specific Tx beam(s)
   The second set has repetition configured to “off” for beams in Set B

The UE 704 first sweeps its Rx beams on the first set to find the best Rx beam, then uses this best Rx beam to measure the second set.
3. Quasi-Rx beam assumption (Type 3): The NW configures a single set of AP CSI-RS resources with repetition set to “off” for beams in Set B. The UE 704 uses a quasi-optimal Rx beam (e.g., the previously used Rx beam for communication) to measure Set B.

The UE 704 can distinguish between these Rx beam assumption types by observing the following aspects of the NW configuration:
The number of CSI-ReportConfig and CSI-ResourceConfig associated with the AI reporting
The resourceType of the configured RS resources
The repetition setting of the configured RS resources

If multiple Rx assumptions have the same configuration values, the NW uses the arrangement of the configured RS resource indices to help the UE 704 distinguish between them.

This implicit alignment method eliminates the need for separate signaling to communicate the Rx beam assumption, thereby reducing signaling overhead. It allows the NW to construct AI/ML models based on specific Rx beam assumptions while ensuring that the UE 704 provides measurements using the corresponding assumption.

The disclosed techniques may enhance the efficiency of AI/ML-based beam management in 5G and beyond wireless systems, particularly in millimeter wave (mmWave) frequencies, by optimizing the beam selection process between the base station 702 and the UE 704. This approach contributes to improved data rates, reduced latency, and more reliable communications in advanced wireless networks.

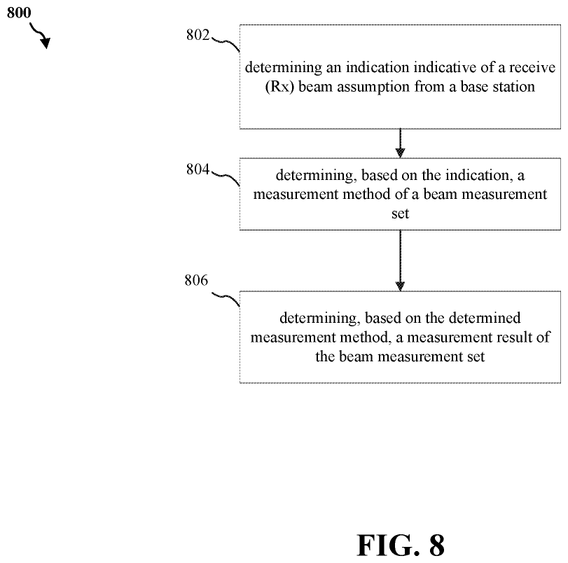

FIG. 8 illustrates a flow chart 800 of a process for beam reporting in an AI/ML-based beam management system. This process involves interactions between a network (NW) and a UE (e.g., the UE 704) through a base station (e.g., the base station 702).

At block 802, the UE determines an indication indicative of a RX beam assumption from a base station 702. This indication may optimize the beam management process, as it defines the parameters and instructions that the UE 704 used for in its measurement and reporting tasks.

At block 804, the UE determines, based on the indication, a measurement method of a beam measurement set. The beam measurement set, for example, is Set B.

Following the receipt of the determination of the measurement method, at block 806, the UE 704 determines, based on the determined measurement method, a measurement result of the beam measurement set. After that, the UE 704 may report the measurement result to the base station 702, according to the received beam report configuration. This may involve reporting the measured best beams, their corresponding RSRP values, or other specified metrics.

Further, the UE 704 may report a capability parameter set indicating which measurement method of the beam measurement set the UE supports. The capability parameter set may include various information elements (IEs) that describe the UE's abilities in relation to AI/ML-based beam management. These may include support for different measurement methods of the beam measurement set.

By reporting these capabilities, the UE 704 provides the network with information that allows for more efficient and effective beam management. The network can use this information to optimize its configurations and requests, aligning them with the specific capabilities of each UE. For example, the network may configure the RX beam assumption supported by the UE 704, according to the capability parameter set reported by the UE 704.

For the network-side AI/ML model, there are several RX beam assumption types that the UE 704 may use to measure the Set B of beams. The AI/ML model may be constructed (trained) under the different RX beam assumptions for obtaining the model input.

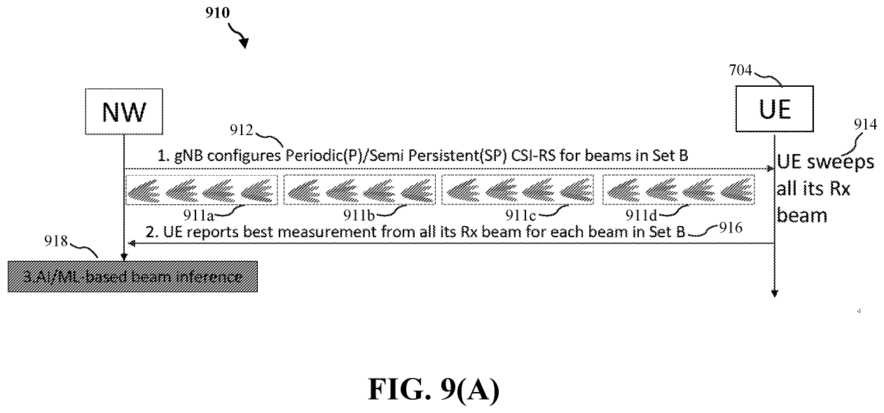

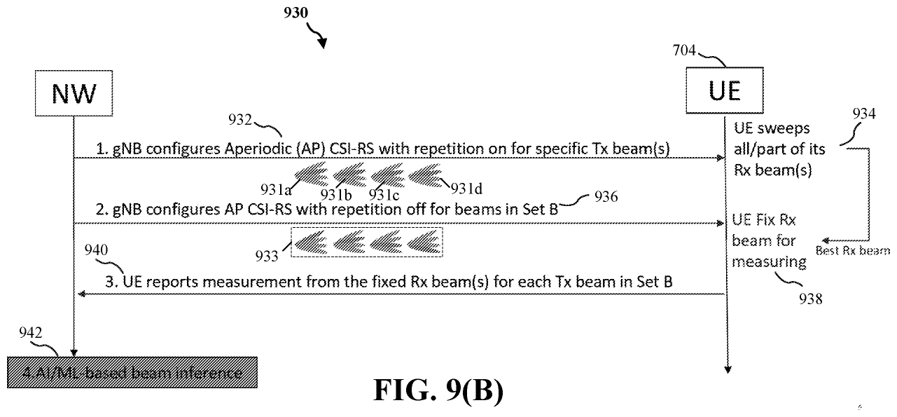

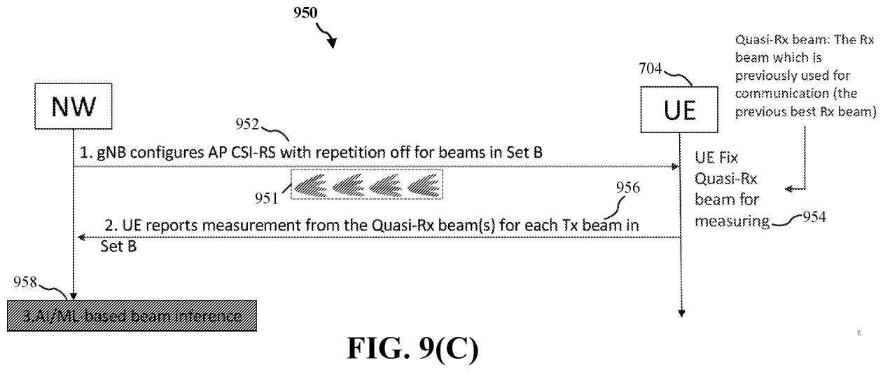

FIG. 9(A) is a diagram 910 illustrating a Rx beam assumption type and a corresponding measurement method for the UE 704. Several Rx beam assumption types may be used by the UE 704 to measure the Set B beams. AI/ML models can be constructed and trained under these different Rx beam assumptions to obtain the model input.

This example illustrates the first type of Rx beam assumption, known as the Best Rx beam assumption. In this type, each Tx beam in Set B is measured by all available Rx beams of the UE 704, and the corresponding model input is obtained by selecting the best measurement among all the used Rx beams.

At operation 912, the network (NW) via the base station 702 configures Periodic (P) or Semi Persistent (SP) CSI-RS for beams in Set B. In this example, the NW transmits Set B four times in total, represented by beam sets 911a, 911b, 911c, and 911d. These beam sets are transmitted periodically over a given period. Each beam set may include multiple beams, typically four in this case.

At operation 914, the UE 704 sweeps all its Rx beams. For each beam in Set B, the UE 704 performs this sweep multiple times, corresponding to the number of times the NW transmits Set B (four times in this example). This allows the UE 704 to measure each beam in Set B with all of its available Rx beams.

At operation 916, the UE 704 reports the best measurement from all its Rx beams for each beam in Set B. This means that for each beam in Set B, the UE 704 selects the highest L1-RSRP value measured across all its Rx beams and reports this value to the NW.

Finally, at operation 918, the NW performs AI/ML-based beam inference based on the reported measurement results. This inference process uses the reported best measurements as input to the AI/ML model to predict optimal beams for communication.

The NW configures specific parameters for measurement and reporting in this Best Rx beam assumption type. These parameters include:
1. CSI-ReportConfig: This parameter corresponds to the associated RS resources and report configuration.
2. resourceConfigType: This parameter may be within CSI-ReportConfig, and is set to indicate the associated resources are either “periodic” or “semi-persistent”. For example, the existing CSI-ResourceConfig::resourceType parameter can be used.
3. periodicity AndOffset: This parameter may be within CSI-ReportConfig, and indicates the periodicity and offset of the associated resources. For example, the existing NZP-CSI-RS-Resource::periodicity AndOffset parameter can be used.
4. reportSlotConfig: This parameter in CSI-ReportConfig specifies the periodicity and offset of the report.

The combination of periodicityAndOffset and reportSlotConfig allows the UE 704 to sweep multiple of its available Rx beams. The period value indicated by reportSlotConfig should contain multiple periods of the configured resources to enable the UE 704 to perform multiple Rx beam sweeps. For example, in FIG. 9(A), the period value of reportSlotConfig can be set to slots64 and the period value of periodicity AndOffset can be set to slots16, which allows NW to transmit Set B four times in total within one report period.

When the UE 704 is configured to report for a network-side AI/ML functionality and receives a periodic or semi-persistent resource type as resourceConfigType, along with a reportSlotConfig indicating a period value that allows for multiple periods of the associated resources, the UE 704 may use the Best Rx beam assumption type. Under this assumption, the UE 704 sweeps multiple of its Rx beams and reports the best measurement among all the swept Rx beams for each reported RS resource. This method allows the NW to obtain the best possible measurements for each beam in Set B, which can lead to more accurate AI/ML model predictions.

FIG. 9(B) is a diagram 930 illustrating a specific RX beam assumption type and a corresponding measurement method for the UE 704. This type represents the second RX beam assumption type, where each TX beam in Set B is measured by a specific UE's RX beam. The specific RX beam is determined by the UE 704 performing beam sweeping on specific TX beam(s) configured by the network (NW).

In this scenario, the NW, via the base station 702, configures two sets of Aperiodic (AP) CSI-RS resources with different repetition settings. At operation 932, the NW configures AP CSI-RS with repetition turned on for specific TX beam(s). These specific TX beams, represented by beam sets 931a, 931b, 931c, and 931d, may be selected from Set B or assigned from outside of Set B, depending on the NW configuration. In some cases, the specific TX beam(s) can be the previous best TX beam(s). The specific TX beam(s) can also be a random Set B beam.

At operation 934, the UE 704 performs a beam sweep using all or part of its available RX beams. The UE 704 measures the specific TX beam(s) transmitted repetitively by the NW, aiming to identify the best RX beam. This process allows the UE 704 to determine the optimal RX beam for subsequent measurements.

Following the RX beam selection, at operation 936, the NW configures AP CSI-RS with repetition turned off for the beams in Set B, represented by beam set 933. This configuration allows the NW to transmit the Set B beams once to the UE 704.

At operation 938, the UE 704 utilizes the best RX beam identified in the previous step to measure each beam in Set B. This fixed RX beam is used to obtain measurement results for all the beams in Set B, providing consistency in the measurements.

Subsequently, at operation 940, the UE 704 reports the measurement results to the NW. Each reported measurement corresponds to a specific beam in Set B, measured using the fixed best RX beam. Finally, at operation 942, the NW performs AI/ML-based beam inference based on the reported measurement results, using this data to optimize beam selection and management.

The NW may configure this specific RX beam assumption type through different reporting structures. In one configuration, the NW may set up two consecutive reports. The first report is associated with one or multiple RS resources having an “Aperiodic” resource type (set by the “resourceType” parameter) and repetition configured to “on” (set by the “repetition” parameter). The second report is also associated with one or multiple RS resources with an “Aperiodic” resource type, but with repetition configured to “off”.

When the UE 704 receives this configuration for a network-side AI/ML functionality, it interprets it as an instruction to use the specific RX beam assumption type. The UE 704 then performs a repetitive sweep of its RX beams, measuring the resources indicated by the first report configuration to identify the best RX beam. Subsequently, it uses this best RX beam to measure the resources indicated by the second report configuration (Set B) once and reports these measurements to the NW.

In an alternative configuration, the NW configures a single report associated with two sets of resources, rather than two separate reports as described in the previous embodiment. The first set of resources has an Aperiodic resourceType with repetition configured to “on”, while the second set has an Aperiodic resourceType with repetition configured to “off”. This configuration allows the NW to combine the beam sweeping and measurement phases into a single report, potentially reducing signaling overhead.

When the UE 704 receives this configuration for a NW-sided AI/ML functionality, it interprets it as an instruction to use the Rx beam assumption Type 2. The UE 704 then follows a two-step process:
1. The UE 704 sweeps one or multiple of its Rx beams by measuring on the first set of resources (with repetition “on”). This allows the UE 704 to identify the best Rx beam corresponding to the best measurement.
2. The UE 704 then uses this best Rx beam to measure the second set of resources (with repetition “off”) and reports the measurements to the NW.

FIG. 9(C) is a diagram 950 illustrating a quasi-RX beam assumption type and a corresponding measurement method for the UE 704. This represents the third type of RX beam assumption, where each TX beam in Set B is measured by the UE 704 using a quasi-optimal RX beam. The quasi-optimal RX beam is an RX beam that was optimal before the current beam management instance, typically the RX beam previously used for communication.

In this scenario, at operation 952, the network (NW) via the base station 702 configures Aperiodic (AP) CSI-RS with repetition turned off for beams in Set B, represented by beam set 951. Unlike the previous RX beam assumption types, the NW does not configure a separate set of beams for RX beam determination. Instead, it relies on the UE 704 to use a quasi-optimal RX beam based on historical information.

At operation 954, the UE 704 employs a fixed quasi-optimal RX beam to measure each beam in Set B. This quasi-optimal RX beam can be determined through various methods. One approach is to use the RX beam that was employed in the most recent data transmission. Alternatively, the UE 704 might measure the Synchronization Signal Block (SSB) and identify the best RX beam for each SSB, then use this beam for measuring Set B. The key aspect is that the UE 704 utilizes past information to determine the most suitable RX beam for the current measurement.

Subsequently, at operation 956, the UE 704 reports the measurement results to the NW. Each reported measurement corresponds to a specific beam in Set B, measured using the fixed quasi-optimal RX beam. Finally, at operation 958, the NW performs AI/ML-based beam inference based on the reported measurement results, using this data to optimize beam selection and management.

In this scenario, the network (NW) configures a single report associated with one or multiple RS resources. These resources are characterized by an Aperiodic resourceType and have their repetition parameter configured to “off”. This configuration differs from the previous two types, as it relies on the UE 704's ability to utilize historical information to determine the most suitable RX beam for measurement.

The quasi-RX beam is not necessarily the optimal beam at the current moment but rather a beam that has demonstrated good performance in recent past communications. This approach uses the temporal correlation of channel conditions, assuming that a beam that performed well in the recent past is likely to perform well in the current measurement instance.

To accommodate various methods of obtaining the quasi-RX beam, the NW employs an innovative technique using the arrangement of associated RS resource indices. This method allows the NW to implicitly indicate which method the UE 704 should use to determine the quasi-RX beam, without the need for additional signaling.

If the UE 704 supports N different methods for obtaining the quasi-RX beam, the NW can use the parameter nzp-CSI-RS-Resources to encode this information. The value of this parameter follows the pattern {N·i+n}, where i={0,1,2,3, . . . , number_of_SetB}, and n represents the specific quasi-RX beam method that the UE 704 should employ, as indicated by the NW.

For example, if the UE 704 supports three methods (N=3), the NW could use the following patterns: 1. nzp-CSI-RS-Resources: {1,4,7,10, . . . } indicates that the UE 704 should use method 1 to obtain the quasi-RX beam for measurement. 2. nzp-CSI-RS-Resources: {2,5,8,11, . . . } indicates the use of method 2. 3. nzp-CSI-RS-Resources: {3,6,9,12, . . . } indicates the use of method 3.

When the UE 704 is configured to report for a NW-side AI/ML functionality and receives these RS resource and report configurations without any additional report configurations, it interprets this as an instruction to use the quasi-RX beam assumption (Type 3). If the UE 704 supports multiple methods for Type 3, it can distinguish which method to use by observing the configured RS resource ID patterns.

Two primary methods for obtaining the quasi-RX beam are considered in this approach:
1. Using the previously used RX beam: In this method, the UE 704 maintains a record of the RX beam used in the most recent successful communication. This beam is then used as the quasi-RX beam to measure the resources included in the csi-RS-ResourceSet specified in the CSI-ResourceConfig, which is indicated by the CSI-ResourceConfigId.
2. Measuring the always-on Synchronization Signal Block (SSB): In this method, the UE 704 measures the always-on SSB and identifies the best RX beam(s) based on these measurements. These best RX beam(s) are then recorded as the quasi-RX beam(s) and used to measure the resources included in the csi-RS-ResourceSet specified in the CSI-ResourceConfig, as indicated by the CSI-ResourceConfigId.

While the NW indicates which method the UE 704 should use to determine the quasi-RX beam, the NW does not know the specific beam ID that the UE 704 will use. The NW only specifies the method, and the UE 704 applies this method to select the most appropriate quasi-RX beam based on its historical information.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
determining an indication indicative of a receive (RX) beam assumption from a base station;
determining, based on the indication, a measurement method of a beam measurement set; and
determining, based on the determined measurement method, a measurement result of the beam measurement set.

2. The method of claim 1, wherein the indication comprises an implicit indication that is represented by a reference signal (RS) resource and report configuration configured from the base station.

3. The method of claim 2, wherein the RS resource and report configuration comprises a periodic or semi-persistent configuration of a RS resource set for the beam measurement set and a periodic configuration of a beam measurement report.

4. The method of claim 3, wherein based on the configured RS resource set periodicity and beam measurement report periodicity, the UE sweeps an available RX beam set to determine a best measurement result for each beam in the beam measurement set.

5. The method of claim 2, wherein the RS resource and report configuration comprises a first report that is associated with a repeated configuration of a first RS resource set, and a second report that is associated with a one-time configuration of a second RS resource set for the beam measurement set.

6. The method of claim 5, wherein based on the first RS resource set configured repetitively, the UE sweeps an available RX beam set to determine a best RX beam, and based on the best RX beam, the UE determines a measurement result for each beam in the beam measurement set.

7. The method of claim 6, wherein the first RS resource set comprises a previous best transmit (TX) beam.

8. The method of claim 2, wherein the RS resource and report configuration comprises a report that is associated with a repeated configuration of a first RS resource set and a one-time configuration of a second RS resource set for the beam measurement set.

9. The method of claim 8, wherein based on the first RS resource set configured repetitively, the UE sweeps an available RX beam set to determine a best RX beam, and based on the best RX beam, the UE determines a measurement result for each beam in the beam measurement set.

10. The method of claim 9, wherein the first RS resource set comprises a previous best transmit (TX) beam.

11. The method of claim 2, wherein the RS resource and report configuration comprises a one-time configuration of a RS resource set for the beam measurement set.

12. The method of claim 11, wherein based on a quasi-optimal RX beam, the UE determines a measurement result for each beam in the beam measurement set.

13. The method of claim 12, wherein the quasi-optimal RX beam comprises a previously used RX beam, a best RX beam obtained by measuring a synchronization signal block (SSB), or an RX beam obtained by sweeping an available RX beam set based on a specific TX beam.

14. The method of claim 13, wherein the UE determines a determination method of the quasi-optimal RX beam based on a RS resource identifier (ID) pattern configured from the base station.

15. The method of claim 1, wherein the indication comprises an explicit indicator.

16. The method of claim 1, wherein the UE further reports a capability parameter set indicating which measurement method of the beam measurement set the UE supports.

17. An apparatus for wireless communication, the apparatus being a user equipment (UE), comprising:
a memory; and
at least one processor coupled to the memory and configured to:
determine an indication indicative of a receive (RX) beam assumption from a base station;
determine, based on the indication, a measurement method of a beam measurement set; and
determine, based on the determined measurement method, a measurement result of the beam measurement set.

18. The apparatus of claim 17, wherein the indication comprises an implicit indication that is represented by a reference signal (RS) resource and report configuration configured from the base station.

19. The apparatus of claim 18, wherein the RS resource and report configuration comprises a periodic or semi-persistent configuration of a RS resource set for the beam measurement set and a periodic configuration of a beam measurement report.

20. A computer-readable medium storing computer executable code for wireless communication of a user equipment (UE), comprising code to:
determine an indication indicative of a receive (RX) beam assumption from a base station;
determine, based on the indication, a measurement method of a beam measurement set; and
determine, based on the determined measurement method, a measurement result of the beam measurement set.
